(19) United States
(12) Patent Application Publication
(10) Pub. No.: US 2010/0115138 A1
(43) Pub. Date: May 6, 2010

(54) Method and Apparatus for Using a Network

(75) Inventor: Markku Juhani Ala-Vannesluoma, Kangasala (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/262,897

(22) Filed: Oct. 31, 2008

(51) Int. Cl. G06F 15/16

(52) U.S. Cl. 709/250

(57) ABSTRACT

In accordance with an example embodiment of the present invention, an apparatus comprising a processor configured to connect to a network, determine a property associated with the network, and generate an event based at least in part on the determined property and the connection to the network is disclosed.

### TECHNICAL FIELD

The present application relates generally to using a network.

### BACKGROUND

There has been a recent surge in the use of networking devices. The growth of networking devices has been accompanied by a surge in programs utilizing networks to send and receive data. For example, a program may use a network to send and/or retrieve an image, a video, a message, text, and/or the like. To keep up with the demand of networking devices, there are many network options available for a device to use.

### SUMMARY

Various aspects of the invention are set out in the claims.

According to a first aspect of the present invention, an apparatus comprising a processor configured to connect to a network, determine a property associated with the network, and generate an event based at least in part on the determined property and the connection to the network is disclosed.

According to a second aspect of the present invention, a method, comprising connecting to a network, determining a property associated with the network, and generating an event based at least in part on the determined property and the connection to the network is disclosed.

According to a third aspect of the present invention, a computer program product comprising a computer-readable medium bearing computer program code embodied therein for use with a computer, the computer program code comprising code for connecting to a network, code for determining a property associated with the network, and code for generating an event based at least in part on the determined property and the connection to the network is disclosed.

According to a third aspect of the present invention, a computer-readable medium encoded with instructions that, when executed by a computer, perform connecting to a network, determining a property associated with the network, and generating an event based at least in part on the determined property and the connection to the network is disclosed.

### BRIEF DESCRIPTION OF THE DRAWINGS

For a more complete understanding of example embodiments of the present invention, reference is now made to the following descriptions taken in connection with the accompanying drawings in which:

FIG. 1 shows a flow diagram of a method for generating an event according to an example embodiment of the invention;

FIG. 2 shows a flow diagram of another method for generating an event according to an example embodiment of the invention; and

FIG. 3 is a block diagram showing an electronic device according to an example embodiment of the invention; and

FIG. 4 is a block diagram showing a network according to an example embodiment of the invention.

### DETAILED DESCRIPTION OF THE DRAWINGS

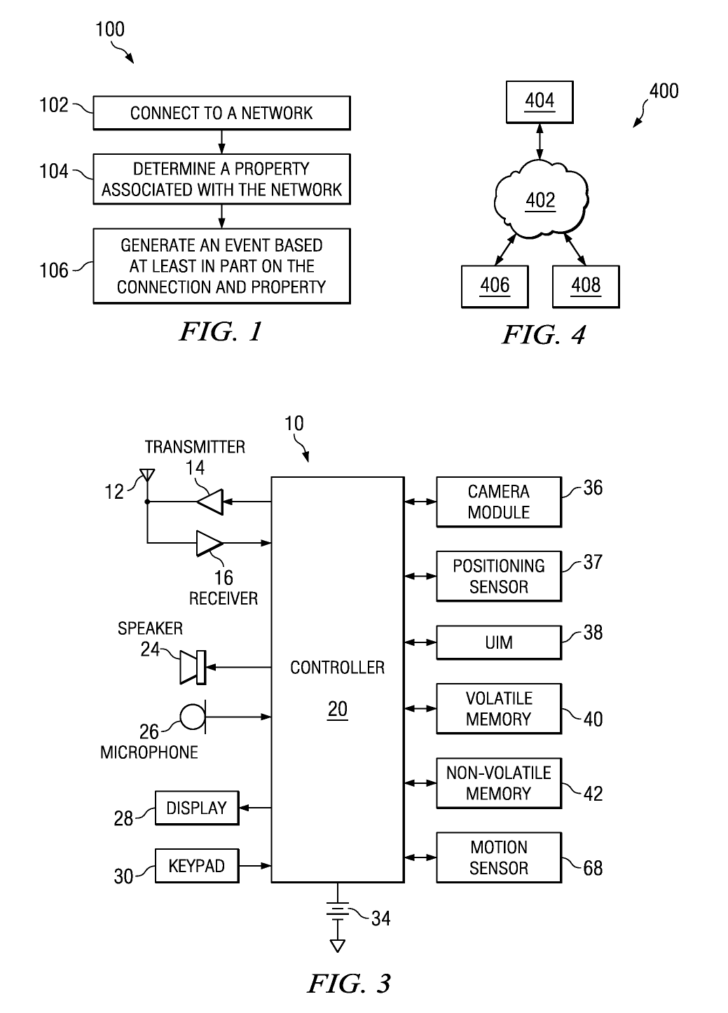

An example embodiment of the present invention and its potential advantages are best understood by referring to FIGS. 1 through 4 of the drawings.

The communication networks available to electronic devices have diverse properties. The networks may vary in one or more properties such as security, cost of use, performance, and/or the like. A network may have one or more properties related to security. For example, a network may have a property relating to access control, and another property relating to encryption. Between one or more networks, the network security properties may vary with respect to access control, encryption, and/or the like. A network may have one or more properties related to cost of use. For example, a network may be substantially free of cost to use and another network may charge for usage. For example, a network may charge one or more fees based at least in part on amount of data transferred, rate of data transferred, time of usage, and/or the like. A network may have one or more properties related to network performance. For example, a network may have one or more properties associated with bandwidth, error rate, and/or the like. A network may have one or more property related to a domain that it accesses. For example, a network may have a property relating to an internet connection, and intranet connection, a telephony network connection, and/or the like.

When an apparatus connects to a network with a property, a program on the apparatus may be allowed to behave differently than the program would behave when the apparatus connects to another network with a different property. For example, a program may determine a data transfer operation based, at least in part, on a network property. In such an example, a program may perform a pending large download whenever connected to an inexpensive network. In another example, a device synchronization program may perform synchronization only when the apparatus connects to an encrypted network. In still another example, a video streaming program may prefer to stream video when a device connects to a high bandwidth network.

In an example embodiment, an apparatus may inform a program when the apparatus determines that it is connected to a network with a property desired by the program. For example, a program may query a Really Simple Syndication (RSS) feed. In such an example, the program may query the RSS feed when the apparatus connects to an inexpensive network.

In another example embodiment, the apparatus starts or notifies a web widget program when the apparatus connects to an inexpensive network. In such an example, the widget program retrieves information when the apparatus connects to the inexpensive network.

FIG. 1 shows a flow diagram of a method 100 for generating an event according to an example embodiment of the invention. An apparatus, for example electronic device 10 of FIG. 3, may be configured to perform method 100.

At block 102, a network, for example network 402 of FIG. 4, is connected to. In an example embodiment, the apparatus may utilize transmitter 14 and/or receiver 16 of FIG. 3 to connect to the network.

At block 104, a property associated with the network is determined. For example, the property may relate to a cost associated with using a network. In such an example, the property may indicate an inexpensive network, a network with an associated cost below a specified rate, and/or the like. In another example, the property may relate to a security capability associated with a network. In such an example, the property may relate to the use of encryption, access restriction, and/or the like. In still another example, the property may relate to performance information. In such an example, performance information may relate to a network's data rate, error rate, and/or the like.

In an example embodiment, a property may be determined from the network connection information. For example, network connection information may comprise information related to security, such as a login requirement, encryption information, and/or the like. In such an example, a security property may be determined by evaluating the security information of the network connection information.

In another example embodiment, a property may be determined from an inherent property of the type of network. For example, an 802.11(b) network may have an associated maximum data rate, such as 11 Mbit/s. In such an example, the property may be determined by utilizing the inherent property.

In still another example embodiment, a property may be determined from information associated with the network. For example, network information may relate to information indicating that there is a cost associated with the use of a network. Such information may vary in specificity. For example, information may indicate that a network is inexpensive. In another example, information may indicate that a network may cost within a range, such as between $1 and $2 per Mbyte. In still another example, information may indicate that a network may cost an amount, such as $5 per use.

In yet another example embodiment, a property may be determined using network information from other networks associated with a network. For example, one or more networks may be grouped together, there may be one or more properties associated with the group of networks. In such an example, the one or more properties may be determined from the network information, an inherent property, information associated with a network, and/or the like, of one or more networks in the group.

In an additional example embodiment, a property may be determined using information obtained using a network. For example, the domain information related to a network may be obtained by using the network. In such an example, the network may be utilized to determine if it allows connection to the internet, an intranet, a telephony network, and/or the like.

At block 106, an event is generated based at least in part on the connection and determined property. In an example embodiment, an event comprises notifying a program, starting a program, and/or the like. For example, the apparatus may notify a program when the apparatus connects to a network that relates to a property desirable to the program. In such an example, the apparatus may notify an email application when the apparatus connects to an encrypted network. In another example, the apparatus may start a downloading program when the apparatus connects to an inexpensive network. The apparatus may base the event, at least in part, on predetermined information, information received from a program, information configured by a user, and/or the like. For example, due to a preconfigured objective, an apparatus may start a data synchronization program when the apparatus connects to an inexpensive network. In another example, an apparatus may notify a weather program when the apparatus connects to an inexpensive network because the weather program requested the notification.

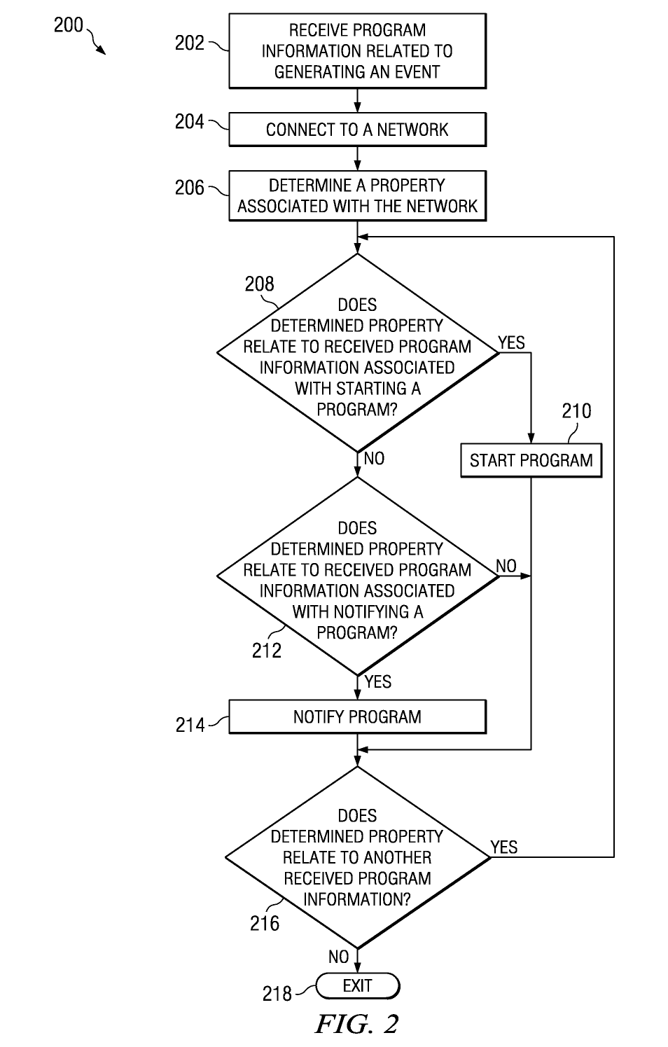

FIG. 2 shows a flow diagram of another method 200 for generating an event according to an example embodiment of the invention. An apparatus, for example electronic device 10 of FIG. 3, may be configured to perform method 200.

At block 202, program information related to generating an event is received. The event may be similar to the event of block 106 of FIG. 1. The program information may comprise information relating to the type of event desired by the program, such as starting, notifying, and/or the like. The program information may comprise information associated with one or more network property desirable to the program. For example, the program information may comprise information related to notifying a program when the apparatus connects to an inexpensive network. The program information may relate to information used to notify a program, start a program, and/or the like. For example, program information may comprise a pathname, an address, a reference, a handle, and/or the like. In an example embodiment, program information comprises an object reference relating to a program requesting to receive a notification. In another example embodiment, program information comprises a pathname relating to a program to be started.

The program information may be received from a program on the apparatus, a program on another apparatus, a predetermined directive, and/or the like. For example, a program may send program information relating to itself and/or another program. In such an example, a program may send information related to having itself started when an inexpensive network is connected to. In another example, an apparatus may receive a predetermined directive, such as a configuration, a setting, and/or the like relating to program information. In such an example, an apparatus may be preconfigured to start a predetermined program when a secure network is connected to. In still another example, a first program may send program information relating to a second program. In such an example, a user interface program may send program information related to starting a different program when a network that is part of a group of networks is connected to.

The apparatus may receive information relating to more than one program and/or one or more events. For example, one program may send program information for a notification when the apparatus connects to a network with a determined property, and another program may send program information for a notification when the apparatus connects to a network with another determined property. In another example, one program may send program information for a notification and information to start when the apparatus connects to a network with a determined property. In still another example, one program may send program information for a notification when the apparatus connects to a network with a determined property, and another program may send program information to be started when the apparatus connects to a network with another determined property.

At block 204, a network is connected to. The network and communication on the network may be similar to the network and communication described with reference to block 102 of FIG. 1.

At block 206, a property associated with the network is determined. The property determination may be similar to the property determination described with reference to block 104 of FIG. 1.

At block 208, it is determined whether the determined property relates to received program information associated with starting at least one program. For example, at block 208, it may be determined whether the program information received at block 202 relates to starting a program when the apparatus connects to a network having the determined property. If it is determined that the determined property does not relate to received program information associated with starting a program, flow proceeds to block 212. If it is determined that the determined property relates to received program information associated with starting at least one program, flow proceeds to block 210.

At block 210, the program is started. Starting a program may comprise instructing an operating system to begin executing a program, retrieving program execution information, and/or the like. For example, block 210 may initiate execution of an email program. After block 210, the apparatus may proceed to block 216.

At block 212, it is determined whether the determined property relates to received program information associated with notifying a program. For example, block 212 may determine whether the program information received at block 202 relates to notifying a program when the apparatus connects to a network having the determined property. If it is determined that the determined property does not relate to received program information associated with notifying a program, flow proceeds to block 216. If it is determined that the determined property relates to received program information associated with notifying a program, flow proceeds to block 214.

At block 214, the program is notified. The notification may inform a program that the apparatus is connected to a network with a property desired by the program. Notifying a program may comprise sending a message to the program, calling a function in the program, invoking a method of the program, storing information in memory used by the program, and/or the like. For example, a synchronization program may receive a message that the apparatus has connected to a secure network. The notification may comprise information related to the network, information related to the property, and/or the like. For example, the notification may comprise information that the program may utilize to perform operations on the network. Such information may be a software object, a message address, a function to call, and/or the like. In another example, the notification may comprise information indicating a security property, a cost property, a performance property, and/or the like.

At block 216, it is determined whether there is another received program information which may relate to the determined property. If it is determined that there is another received program information which may relate to the determined property, the flow returns to block 208. If it is determined that there is not another received program information which may relate to the determined property, the flow is exited at block 218.

FIG. 3 is a block diagram showing an electronic device according to an example embodiment of the invention. It should be understood, however, that a electronic device as illustrated and hereinafter described is merely illustrative of an electronic device that would benefit from embodiments of the present invention and, therefore, should not be taken to limit the scope of the present invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, global positioning system (GPS) devices and other types of electronic systems, may readily employ embodiments of the present invention. Furthermore, devices may readily employ embodiments of the present invention regardless of their intent to provide mobility.

Embodiments of the present invention will be primarily described in conjunction with mobile communications applications. However, it should be understood that embodiments of the present invention may be utilized in conjunction with a variety of other applications, both in the mobile communications industries and outside of the mobile communications industries.

The electronic device 10 comprises an antenna 12 (or multiple antennae) in operable communication with a transmitter 14 and a receiver 16. The electronic device 10 further comprises a controller 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, wireless networking protocols, such as 802.11, short-range wireless protocols, such as Bluetooth, and/or the like.

It is understood that the controller 20 comprises circuitry desirable for implementing audio, video, communication, navigation, logic functions, and or the like. For example, the controller 20 may comprise a digital signal processor device, a microprocessor device, various analog to digital converters, digital to analog converters, and other support circuits. Control and signal processing functions of the electronic device 10 are allocated between these devices according to their respective capabilities. The controller 20 thus may also comprise the functionality to encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional internet browser. The connectivity program may then allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may also comprise a user interface including an output device such as a ringer, a conventional earphone and/or speaker 24, a microphone 26, a display 28, and/or a user input interface, which are coupled to the controller 20. The user input interface, which allows the electronic device 10 to receive data, may comprise any of a number of devices allowing the electronic device 10 to receive data, such as a keypad 30, a touch display (not shown) or other input device. In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the controller 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the controller 20 in the form of software for creating a digital image file from a captured image. In an example embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The electronic device 10 may further comprise a user identity module (UIM) 38. The UIM 38 may be a memory device having a built in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a mobile subscriber. In addition to the UIM 38, the electronic device 10 may be equipped with memory. For example, the electronic device 10 may comprise volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may additionally or alternatively comprise an EEPROM, flash memory or the like. The memories may store any of a number of pieces of information, and data. The information and data may be used by the electronic device 10 to implement the functions of the electronic device 10. For example, the memories may comprise an identifier, such as an international mobile equipment identification (IMEI) code, which may uniquely identify the electronic device 10.

Although FIG. 3 illustrates an example of an electronic device which may utilize embodiments of the present invention, it should be understood that the electronic device 10 of FIG. 3 is merely an example device that may utilize embodiments of the present invention.

A processing element such as those described may be embodied in various ways. For example, the processing element may be embodied as a processor, a coprocessor, a controller or various other processing means or devices including integrated circuits such as, for example, an ASIC (application specific integrated circuit), FPGA (field programmable gate array), and/or the like.

FIG. 4 is a block diagram showing a network according to an example embodiment of the invention.

In an example embodiment, block 402 relates to a network and blocks 404, 406, and 408 relate to devices, such as electronic device 10 of FIG. 3. The network 402 may be used to allow devices to communicate. For example, devices 404 and 406 may communicate using the network 402.

The network may be a wired network, such as Ethernet, a second-generation (2G) wireless communication network such as, IS-136 (TDMA), GSM, IS-95 (CDMA), and/or the like. In another example, the network may be a third-generation (3G) wireless communication network, such as UMTS, CDMA2000, WCDMA TD-SCDMA, and/or the like. In still another example, the network may be a fourth-generation (4G) wireless communication network, a wireless local area network, such as 802.11, a short-range wireless network, such as Bluetooth, and/or the like.

Communication on the network may utilize one or more protocols. For example, the connection may utilize Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like.

Without in any way limiting the scope, interpretation, or application of the claims appearing below, a technical effect of one or more of the example embodiments disclosed herein may be improving a programs usage of network resources by allowing it to be informed when a network is suitable for the program's transmission purposes without polling. Another technical effect of one or more of the example embodiments disclosed herein may be reducing program queries related to network information. Another technical effect of one or more of the example embodiments disclosed herein may be improving the way a program uses available network resources.

Embodiments of the present invention may be implemented in software, hardware, application logic or a combination of software, hardware and application logic. The software, application logic and/or hardware may reside on an integrated circuit, an internal device, or an external device. If desired, part of the software, application logic and/or hardware may reside on an integrated circuit, part of the software, application logic and/or hardware may reside on an internal device, and part of the software, application logic and/or hardware may reside on an external device. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a processor configured to
connect to a network;
determine a property associated with said network; and
generate an event based at least in part on said determined property and said connection to said network.

2. The apparatus of claim 1, wherein said event comprises starting a program.

3. The apparatus of claim 1, wherein said event comprises notifying a program.

4. The apparatus of claim 3, wherein said notification comprises information related to said network.

5. The apparatus of claim 3, wherein said notification comprises information related to said property.

6. The apparatus of claim 1, wherein said network is a wireless network.

7. The apparatus of claim 1, wherein said network is a cellular network.

8. The apparatus of claim 1, wherein said property relates to cost.

9. The apparatus of claim 1, wherein said property relates to security.

10. The apparatus of claim 1, wherein said property relates to performance.

11. The apparatus of claim 1, wherein said property relates to inclusion in a group of networks.

12. The apparatus of claim 1, wherein said processor is further configured to receive program information.

13. The apparatus of claim 12, wherein said program information comprises a desired network property.

14. The apparatus of claim 12, wherein said program information relates to starting a program.

15. The apparatus of claim 12, wherein said program information relates to notifying a program.

16. The apparatus of claim 12, wherein said processor is further configured to determine said event based at least in part on said program information.

17. The apparatus of claim 1, wherein said processor comprises at least one memory that contains executable instructions that if executed by said processor cause said apparatus to:
connect to a network;
determine a property associated with said network; and
generate an event based at least in part on said determined property and said connection to said network.

18. A method, comprising:
connecting to a network;
determining a property associated with said network; and
generating an event based at least in part on said determined property and said connection to said network.

19. The method of claim 18, wherein said event comprises starting a program.

20. The method of claim 18, wherein said event comprises notifying a program.

21. The method of claim 18, wherein said property relates to cost.

22. The method of claim 18, wherein said property relates to security.

23. A computer program product comprising a computer-readable medium bearing computer program code embodied therein for use with a computer, the computer program code comprising:
code for connecting to a network;
code for determining a property associated with said network; and
code for generating an event based at least in part on said determined property and said connection to said network.

24. A computer-readable medium encoded with instructions that, when executed by a computer, perform:
connecting to a network;
determining a property associated with said network; and
generating an event based at least in part on said determined property and said connection to said network.
